(19) United States
(12) Patent Application Publication
(10) Pub. No.: US 2006/0055516 A1
(43) Pub. Date: Mar. 16, 2006

(54) Visual communication safety system for off-road vehicles

(76) Inventor: Christopher P. Sawicki, Sutton, MA (US)

Correspondence Address: BLODGETT BLODGETT, 43 HIGHLAND STREET, WORCESTER, MA, 016092797, US

(21) Appl. No.: 11/217,075

(22) Filed: Aug. 31, 2005

Related U.S. Application Data
(60) Provisional application No. 60/607,294, filed on Sep. 7, 2004.

(51) Int. Cl. B60Q 1/00; B60Q 1/26

(52) U.S. Cl. 340/425.5; 340/468

(57) ABSTRACT

The communication safety system overcomes the disadvantages of hand signaling between drivers of off-road vehicles. Two or more light sources, e.g., high intensity Light Emitting Diodes (LED's), are mounted in a casing that is attached to the body of an off-road vehicle or to the driver's helmet. The LED's can be activated in different combinations to signal to oncoming drivers that a driver with a communication safety system is the first or last in a train of vehicles or that more vehicles are approaching. By using the communication safety system, a driver is relieved of the need to use hand signals, which involves taking one hand off of the handlebars of an off-road vehicle.

### CROSS-REFERENCE TO RELATED APPLICATIONS

This application claims the benefit under 35 U.S.C. section 119(e) of U.S. Provisional Application No. 60/607,294 filed Sep. 7, 2004, which is hereby incorporated by reference.

### STATEMENT REGARDING FEDERALLY SPONSORED RESEARCH OR DEVELOPMENT

This invention has been created without the sponsorship or funding of any federally sponsored research or development program.

### BACKGROUND OF THE INVENTION

1. Field of the Invention

The present invention relates to communication systems, and more particularly to a communications safety system having a plurality of lights that can be attached to the body of an off-road vehicle or to the helmet of a driver of the off-road vehicle in order to alert other drivers of oncoming traffic.

2. Description of the Related Art

Drivers of off-road vehicles, such as snowmobiles, All Terrain Vehicles (“ATVs”), and dirt bikes, use hand signals to communicate with other drivers utilizing off-road trails when they are going to turn or slow down, or to signal other drivers that they are the first in a group of riders. Communications and hand signals have become increasingly important to the drivers of off-road vehicles because trails have become increasingly crowded and off-road vehicles have become and increasingly powerful and subsequently more dangerous.

Hand signaling is typically done with the left hand, and examples include extending in the left arm to signal that the driver is turning left or raising the left arm with one thumb pointing backward to signal that vehicles are following. A drawback to the traditional hand-signaling method is that a driver must release his or her left hand from the handlebar/brake to make the signal, which can be dangerous in rough terrain, since a driver's control of the off-road vehicle is reduced by operating the vehicle with one hand.

The signal for oncoming vehicles, for following vehicles, and the signal for the last vehicle in line are especially important because oncoming drivers must be particularly cautious when other drivers are sharing a trail and the chance of collision increases. One way to signal other drivers while leaving both hands on the handlebars is through the use of lights either on the frame of the off-road vehicle or on the helmet.

As a general matter, a variety of devices and methods of illuminating a helmet or off-road vehicle have been proposed:

U.S. Pat. No. 4,186,429, issued Jan. 29, 1980 to Walter A. Johnston, shows a flashing light safety device for cyclists' helmets that features battery power as an option. U.S. Pat. No. 4,195,328, issued Mar. 25, 1980 to William R. Harris, Jr. describes an auxiliary motorcycle headlight mounted on the cyclist's helmet that includes both a quartz headlight-and an amber parking light. U.S. Pat. No. 5,488,361, issued Jan. 30, 1996 to Joseph W. Perry, discloses navigation lights for personal watercraft operators that feature red, green, and white lights attached to the sides and back, respectively, of the user's helmet and life jacket. U.S. Pat. No. 5,544,027, issued Aug. 6, 1996 to Anthony Orsano teaches an LED display for a protective helmet and a helmet containing the same or to which the LED display is attached.

Ornamental designs for helmets having lighting devices attached thereto are shown in U.S. Design Pat. No. 406,400, issued Mar. 2, 1999 to Darryl William Munns (design for a safety light helmet featuring a single bulb); U.S. Design Pat. No. 424,247, issued May 2, 2000 to Rommel Deleon (design for a safety helmet with attached brake light); and U.S. Design Pat. No. 475,161 S* issued May 27, 2003 to Paul D. Mundy (design for a sports enthusiast's a helmet with battery-powered strobe unit). U.S. Patent Publication No. 2004/0052068, published Mar. 18, 2004, describes a helmet having a solar-powered warning device.

Other illuminated safety helmets are shown in U.S. Pat. No. 5,357,409, issued Oct. 18, 1994 to Terry L. Glatt (illuminated safety helmet); U.S. Pat. No. 5,688,039, issued Nov. 18, 1997 to Lyndon F. Johnson (safety helmet with adjustable front beam light and flashing rear light); U.S. Pat. No. 5,743,621, issued Apr. 28, 1998 to Robert L. Mantha et al. (safety helmet with front and back diode modules switched on and off by chin strap switch); U.S. Pat. No. 5,871,271, issued Feb. 16, 1999 to Tseng Lu Chien (LED illuminated protective headwear with LED's mounted on separate reflectors and arranged to display messages or designs controlled by user operated switch); U.S. Pat. No. 6,113,244, issued Sep. 5, 2000 (fiber optic lighted helmet); U.S. Pat. No. 6,244,721, issued Jun. 12, 2001 to Mark F. Rodriguez et al. (illuminated helmet device with pressure switch in helmet); U.S. Pat. No. 6,461,015, issued Oct. 8, 2002 to Charles D. Welch (portable wearable strobe light); U.S. Pat. No. 6,497,493, issued Dec. 24, 2002 to David A. Thiesen (illuminated safety helmet with light at rear attached by clip); U.S. Pat. No. 6,648,489, issued Nov. 18, 2003 to Ernst W. Fischer et al. (removable helmet light system); United Kingdom Patent Application No. 2,107,039, published Apr. 20, 1983 (protective headwear); and International Patent No. WO 93/22160, published Nov. 11, 1993 (headgear with safety light).

None of the above inventions and patents, taking either singly or in combination, is seen to describe the instant invention as claimed. Thus, a communication safety system solving the aforementioned problems is desired.

### BRIEF SUMMARY OF THE INVENTION

The communication safety system overcomes the disadvantages of hand signaling between drivers of off-road vehicles. The system includes at least one optical signaling device having a plurality of light sources, e.g., high intensity Light Emitting Diodes (LED's), mounted in a small casing that is attached to the body of an off-road vehicle or to the driver's helmet. The LED's are activated in different combinations to signal to oncoming drivers that a driver with the signaling device is the first or last in a train of vehicles, or that more vehicles are approaching. By using the communication safety system, a driver is relieved of the need to use hand signals, which involves taking one hand off of the handlebars of the off-road vehicle for an extended period.

The signaling device is a self-contained unit wherein the LED's, power source, and a low-profile push button are in the same open-ended casing. A user attaches the signaling device to either the helmet or to the off-road or vehicle using adhesive, cement, snaps, hook and loop fasteners, or other suitable fasteners. The signaling device may be either may permanently or temporarily attached.

The signaling device is attached with the open end facing forward so that the LED's are visible to incoming drivers. The LED's are wired to the power source and a push button. In one embodiment of the signaling device having three LED's, a driver depresses the push button once to activate the center LED to signal that he or she is the first driver in a train of drivers. By depressing the push button twice, the outboard two LED's are activated to flash, thereby signaling that the driver is one in a train of drivers.

In another embodiment of the invention, one light source on the first vehicle in a line (for example, a yellow light) would communicate that the vehicle is the first in a line, and another light source on the last vehicle in a line (for example, a green light) would communicate that the vehicle is the last vehicle in the line. The intermediate vehicles could bear yellow lights to indicate that they are not last, that is, that there is a following vehicle.

The light signal could be produced by different colored lights or LED's, or could be the result of different colored lenses over the same colored light or LED, for example if the lenses were changeable.

The communications safety system encompasses a plurality of off-road vehicles in which either each driver or each off-road vehicle is equipped with a helmet-mounted or vehicle-mounted optical signaling device, so that all drivers understand the signaling protocol to be used in operating the signaling device.

Accordingly, it is a principal object of the invention to replace conventional hand signaling between drivers of off-road vehicles with a communication safety using system using optical signaling devices.

It is another object of the invention to provide a method of communication between drivers of off-road vehicles that is safe and efficient.

It is an object of the invention to provide improved elements and arrangements thereof for the purposes described which is inexpensive, dependable, and fully effective in accomplishing its intended purposes.

These and other objects of the present invention will become readily apparent from further review of the following specification and drawings.

### BRIEF DESCRIPTION OF THE DRAWINGS

The character of the invention, however, may best be understood by reference to one of its structural forms, as illustrated by the accompanying drawings, in which:

FIG. 1 is a perspective view of an embodiment of an optical signaling device for a communication safety system according to the present invention;

FIG. 2 is a front view of the signaling device of FIG. 1;

FIG. 3 is a side view of the signaling device of FIG. 1;

FIG. 4 is a top view of the signaling device of FIG. 1;

FIG. 5 is a front view of the signaling device of FIG. 1 attached to various positions on a driver's helmet; and

FIG. 6 is a side view of the signaling device of FIG. 1 attached to the front end of a snowmobile.

Similar reference characters denote corresponding features consistently throughout the attached drawings.

### DETAILED DESCRIPTION OF THE INVENTION

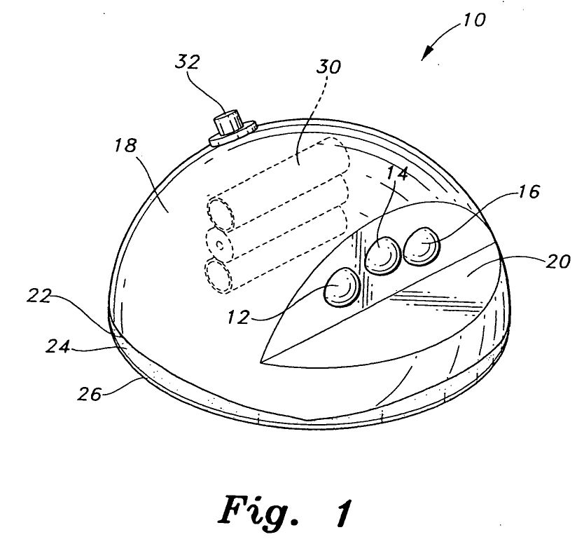

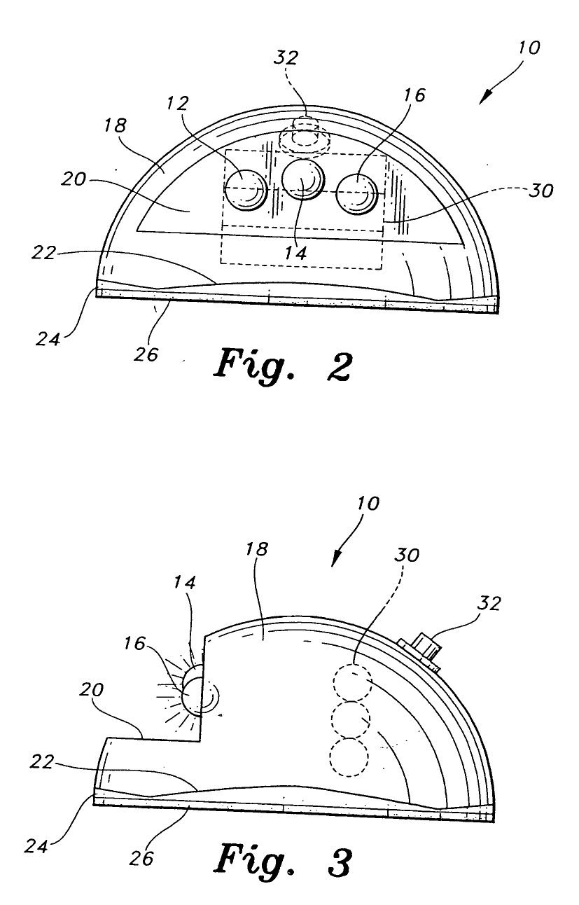

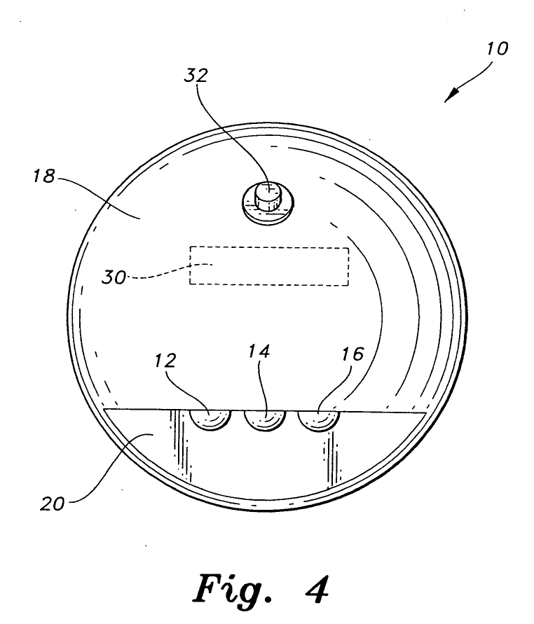

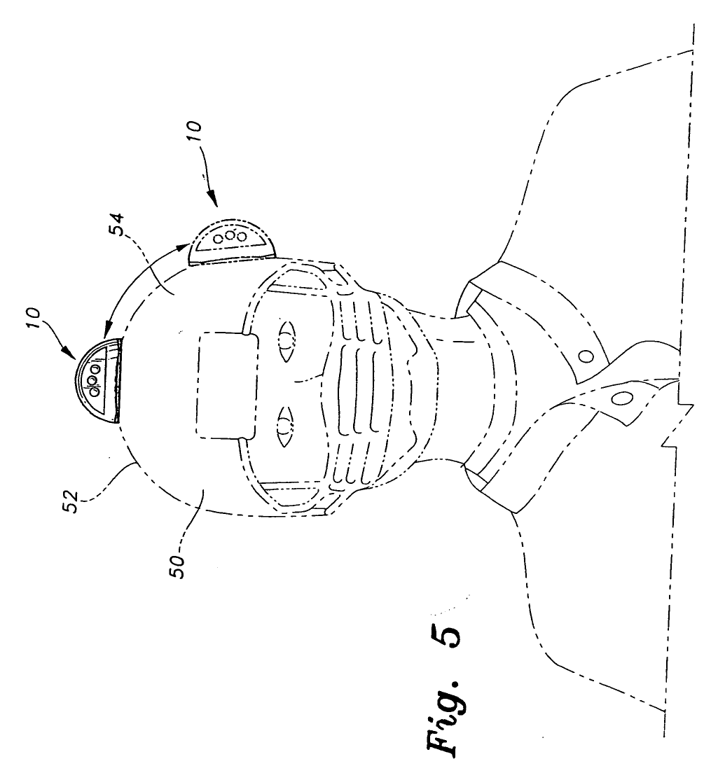

The present invention is a communication safety system. The system includes at least one optical signaling device, an embodiment of which is designated generally as 10 in the drawings. The signaling device 10 includes a plurality of light sources. In the embodiment shown in FIGS. 1, 2, 3, and 4, the optical signaling device 10 includes three light sources, e.g., high intensity Light Emitting Diodes (LED's) 12, 14, and 16, that are mounted in a casing 18. In the embodiment shown, the casing 18 is dome-shaped with an open front end 20 where the LED's 12, 14, and 16 are placed.

The casing 18 has a substantially concave bottom 22 that is lined with shock absorbent material 24, such as rubber. The flexibility of the shock absorbent material 24 allows the signaling device 10 to be mounted on uneven or curved surfaces.

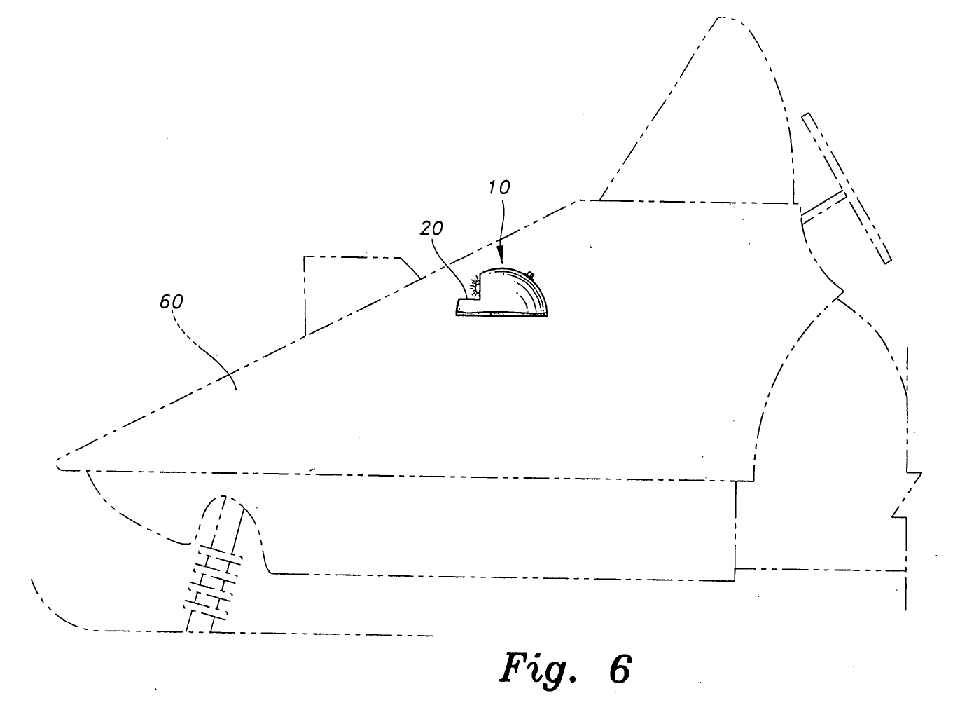

FIGS. 5 and 6 show the optical signaling device 10 mounted in different ways but always so that the open front end 20 is facing forward so that the LED's 12, 14, and 16 are visible to oncoming drivers. FIG. 5 shows the signaling device 10 mounted on different portions of a driver's helmet 50. The signaling device 10 can be mounted on the top 52 of the helmet 50 (shown in solid lines) or on the side 54 of the helmet (shown in phantom lines).

FIG. 6 shows the signaling device 10 mounted front, left hand side of a snowmobile 60. The signaling device 10 can be attached to the helmet or body of an off-road vehicle in different ways. In the embodiment shown, two-sided adhesive tape 26 is attached to the underside of the shock absorbent material 24 and then the signaling device 10 is attached according to the driver's preference.

In addition to two-sided adhesive tape 26, any other suitable attaching means, including adhesive cement, hook and loop fasteners, or other fasteners, may be employed for permanent or temporary mounting. The signaling device 10 is mounted with the open front end 20 facing forward so that the LED's 12, 14, and 16 are visible to oncoming drivers. The LED's are wired to a power source, which are shown in the drawings as batteries 30, and a push button 32.

It is contemplated that other power sources could be used, including hardwiring the communication safety system 10 to the electrical system of the off-road vehicle. The pushbutton 32 is located on the rear of the casing 18. To use the communication safety system 10, a driver would depress the push button 32 once to activate the center LED 14 to signal that no other drivers' are following. By depressing the push button 32 twice (the second “push” may have to be done within a timed interval after the first “push”), the outboard two LED's 12 and 16 are activated to flash thereby signaling that other drivers are following. The push button switch 32 may be in a normally off position, with no diodes illuminated initially, and may continue in the elected one-push or two-push state until the next time the button 32 is depressed, upon which power to the diodes is removed.

Alternatively, the diodes may always be on in one pattern or another, simply toggling between patterns whenever the push button 32 is depressed. Once the driver has depressed the push button 32 to activate the appropriate signal, the driver need not remove his or her hands from the vehicle to communicate with other drivers.

In order to enhance quick visual recognition of the message, the LED's may be different colors, e.g., the center LED 14 may be green while two outboard flashing LED's 12 and 16 may be yellow. The use of more than two LED's and different colors is contemplated for use with the communication safety system.

The communication safety system may employ optical devices other than LED's.

Although the communications safety system can have some effectiveness with a single optical signaling device 10 when other off-road vehicle operators understand the message protocol employed by the driver having the single signaling device 10, it is contemplated that the driver of each off-road vehicle in the system will have an optical signaling device attached to either the off-road vehicle itself, or to the driver's helmet, and that all drivers in the system will operate the signaling device according to the same protocol.

It will be understood that the particular physical configuration of the signaling device shown in the drawings is exemplary only, and other configurations with more or fewer lights, different casing styles, sources, alternative switch locations, etc., are within the scope of the invention as claimed.

Further, although the communication safety system has been illustrated as conveying messages regarding whether there are trailing vehicles, the system may be used to convey any other warning or traffic control messages agreed upon by protocol.

The foregoing specification recites several objects, advantages and features which are independent of each other, i.e., each of the following claims is commensurate with at least one such object, advantage or feature, but not necessarily all such objects, advantages or features.

It is to be understood that the present invention is not limited to the embodiments described above, but encompasses any and all embodiments within the scope of the following claims.

The invention having been thus described, what is claimed as new and desired to secure by Letters Patent is:

What is claimed is:

1. A communication safety system, comprising:
a casing;
a plurality of light sources located on a portion of the casing in a visually observable location;
an electrical circuit connecting the light sources to a power source, a switch forming part of the electrical circuit; and
wherein the switch is located for access and activation by a user to selectively operate a first light source of the plurality of light sources thereby communicating a first safety message to other users and to selectively operate a plurality of the light sources thereby communicating a second safety message to other users.

2. An optical signaling device for a communication safety system, the device comprising:
a casing adapted for selective mounting to an off-road vehicle and a driver's helmet;
a plurality of light emitting diodes mounted In the casing;
an electrical circuit electrically connected to the diodes; and
a user-operable switch electrically connected to the electrical circuit, the switch having a first state in which the electrical circuit is configured for illuminating the diodes in a first message pattern and a second state In which the electrical circuit is configured for illuminating the diodes in a second message pattern.

3. A communication safety system for a plurality of off-road vehicles, comprising at least one optical signaling device adapted for selectively being attached to one of the off-road vehicles or to a driver's helmet, the optical signaling device having:
a casing;
a plurality of light emitting diodes mounted in the casing;
an electrical circuit electrically connected to the diodes, the circuit being configured for illuminating the diodes in a plurality of selectable patterns; and
means operable by a driver of the off-road vehicle for switching the electrical circuit between the selectable patterns;
whereby the driver selects and displays one of the selectable patterns for conveying a message to drivers of the other off-road vehicles using the system.

4. A communication safety system for a plurality of off-road vehicles in a line, including a first vehicle in the line and a last vehicle in the line, the system comprising:
at least a first light emitting signaling device aboard the first vehicle, said device being adapted to emit a first forward facing visual signal indicative that the devise is on the first vehicle in a line;
at least a second forward facing light emitting signaling device aboard the last vehicle in the line;
said second device being adapted to emit a last signal visually; and distinguishable from the first signal and indicative that the last vehicle is the last vehicle.

5. A communication safety system as recited in claim 4, wherein each the optical signaling device has a casing.

6. A communication safety system as recited in claim 4, wherein each device has a casing and a plurality of light emitting diodes mounted in the casing.

7. A communication safety system as recited in claim 4, wherein each device has light emitting diodes and an electrical circuit electrically connected to the diodes, the circuit being configured for illuminating the diodes in a plurality of selectable patterns.

8. A communication safety system as recited in claim 4, wherein each device includes means operable by a driver of the off-road vehicle for switching the electrical circuit between at least two selectable patterns.

9. A communication safety system as recited in claim 4, wherein each device has a means whereby the driver selects and displays one of at least two selectable patterns for conveying a message to drivers of the other off-road vehicles using the system.

10. A communication safety system as recited in claim 4, wherein each device has a selector adapted to select whether to device emits the first or the second signal.

11. A communication safety system as recited in claim 4, wherein the system includes intermediate vehicles, each of which have onboard a device adapted to emit a signal different from the last signal.

12. A communication safety system as recited in claim 4, wherein the system includes intermediate vehicles, each of which have onboard an intermediate light emitting device adapted to emit an intermediate signal different from the last signal, and wherein the intermediate devices emit a signal that is the same as the first signal.
